(19) United States
(12) Patent Application Publication
(10) Pub. No.: US 2023/0031536 A1
(43) Pub. Date: Feb. 2, 2023

(54) CORRECTING LIP-READING PREDICTIONS

(71) Applicant: Sony Group Corporation, Tokyo (JP)

(72) Inventors: Jong Hwa Lee, San Diego, CA (US); Matthew Wnuk, San Diego, CA (US); Francisco Costela, San Diego, CA (US); Shiwei Jin, San Diego, CA (US)

(73) Assignee: Sony Group Corporation, Tokyo (JP)

(21) Appl. No.: 17/572,029

(22) Filed: Jan. 10, 2022

Related U.S. Application Data
(60) Provisional application No. 63/203,684, filed on Jul. 28, 2021.

(51) Int. Cl. G10L 15/25; G06F 40/40

(52) U.S. Cl. CPC G10L 15/25; G06F 40/40

(57) ABSTRACT

Implementations generally relate to correcting lip-reading predictions. In some implementations, a method includes receiving video input of a user, where the user is talking in the video input. The method further includes predicting one or more words from mouth movement of the user to provide one or more predicted words. The method further includes correcting one or more correction candidate words from the one or more predicted words. The method further includes predicting one or more sentences from the one or more predicted words.

### CROSS REFERENCE TO RELATED APPLICATIONS

This application claims priority from U.S. Provisional Patent Application No. 63/203,684, entitled “NATURAL LANGUAGE PROCESSING FOR CORRECTING LIP-READING PREDICTION,” filed Jul. 28, 2021 (Client Reference No. SYP340532US0), which is hereby incorporated by reference as if set forth in full in this application for all purposes.

### BACKGROUND

Lip reading techniques that recognize speech without relying on audio may result in inaccurate predictions. For example, a lip-reading technique may recognize “Im cord” from the correct expression, “I'm cold.” This is because deep learning models rely on the lip movements without audio assistance. A speaker's mouth shape may be similar for different words such as “buy” and “bye,” or “cite” and “site.” Conventional approaches use an end-to-end deep learning model to make word to sentence predictions. However, there are large gaps between the current state-of-the-art model and real-world inferences. For example, a model may predict merely word or fixed structures such as command+color+preposition+letter+digit+adverb.

### SUMMARY

Implementations generally relate to correcting lip-reading predictions. In some implementations, a system includes one or more processors, and includes logic encoded in one or more non-transitory computer-readable storage media for execution by the one or more processors. When executed, the logic is operable to cause the one or more processors to perform operations including: receiving video input of a user, where the user is talking in the video input; predicting one or more words from mouth movement of the user to provide one or more predicted words; correcting one or more correction candidate words from the one or more predicted words; and predicting one or more sentences from the one or more predicted words.

With further regard to the system, in some implementations, the predicting of the one or more words is based on deep learning. In some implementations, the correcting of the one or more correction candidate words is based on natural language processing. In some implementations, the correcting of the one or more correction candidate words is based on analogy. In some implementations, the correcting of the one or more correction candidate words is based on word similarity. In some implementations, the correcting of the one or more correction candidate words is based on vector similarity. In some implementations, the correcting of the one or more correction candidate words is based on cosine similarity.

In some implementations, a non-transitory computer-readable storage medium with program instructions thereon is provided. When executed by one or more processors, the instructions are operable to cause the one or more processors to perform operations including: receiving video input of a user, where the user is talking in the video input; predicting one or more words from mouth movement of the user to provide one or more predicted words; correcting one or more correction candidate words from the one or more predicted words; and predicting one or more sentences from the one or more predicted words.

With further regard to the computer-readable storage medium, in some implementations, the predicting of the one or more words is based on deep learning. In some implementations, the correcting of the one or more correction candidate words is based on natural language processing. In some implementations, the correcting of the one or more correction candidate words is based on analogy. In some implementations, the correcting of the one or more correction candidate words is based on word similarity. In some implementations, the correcting of the one or more correction candidate words is based on vector similarity. In some implementations, the correcting of the one or more correction candidate words is based on cosine similarity.

In some implementations, a method includes: receiving video input of a user, where the user is talking in the video input; predicting one or more words from mouth movement of the user to provide one or more predicted words; correcting one or more correction candidate words from the one or more predicted words; and predicting one or more sentences from the one or more predicted words.

With further regard to the method, in some implementations, the predicting of the one or more words is based on deep learning. In some implementations, the correcting of the one or more correction candidate words is based on natural language processing. In some implementations, the correcting of the one or more correction candidate words is based on analogy. In some implementations, the correcting of the one or more correction candidate words is based on word similarity. In some implementations, the correcting of the one or more correction candidate words is based on vector similarity. In some implementations, the correcting of the one or more correction candidate words is based on cosine similarity.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example environment for correcting lip-reading predictions, which may be used for implementations described herein.

FIG. 2 is an example flow diagram for correcting lip-reading predictions, according to some implementations.

FIG. 3 is an example diagram showing word vectors used in word predictions based on analogy, according to some implementations.

FIG. 4 is an example diagram showing word vectors used in word predictions based on word similarity, according to some implementations.

FIG. 5 is an example diagram showing a mapping of predicted words to digits, according to some implementations.

FIG. 6 is a block diagram of an example network environment, which may be used for some implementations described herein.

FIG. 7 is a block diagram of an example computer system, which may be used for some implementations described herein.

### DETAILED DESCRIPTION

Implementations described herein correct lip-reading predictions using natural language processing. Implementations described herein address limitations of conventional lip-reading techniques. Such lip-reading techniques recognize speech without relying on an audio stream. This may result in incorrect, inaccurate, or partial predictions. For example, “ayl biy baek” may be recognized instead of the correct expression, “I'll be back.”). “Im cord” may be recognized instead of the correct expression “I'm cold).” “Im frez” may be recognized instead of the correct expression, “I'm freezing.” This is because the deep learning model relies on the lip movements without audio assistance. A speaker's mouth shape is similar between “buy” and “bye”, or “cite” and “site.” Natural language processing (NLP) may be used in an artificial intelligence (AI) deep learning model to understand the contents of documents, including the contextual nuances of the language within them. This applies to written language.

Implementations described herein provide a pipeline using NLP to correct wrong or inaccurate predictions derived from machine learning output. For example, a machine learning model may predict “Im cord” from lip motion of speaker, where audio is absent. Implementations described herein involve NLP techniques to takes the words “Im cord” as an input and corrects the wording to the correct expression, “I'm cold.” Implementations described herein apply to not only to fixed structures but also to unstructured formats by utilizing NLP.

As described in more detail herein, in various implementations, a system receives video input of a user, where the user is talking in the video input. The system further predicts one or more words from the mouth movement of the user to provide one or more predicted words. The system further corrects one or more correction candidate words from the one or more predicted words. The system further predicts one or more sentences from the one or more predicted words.

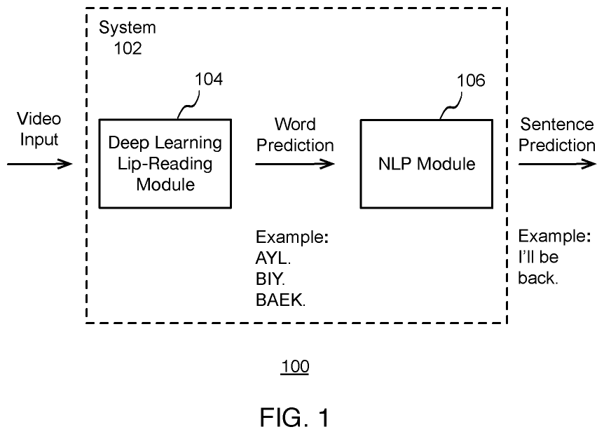

FIG. 1 is a block diagram of an example environment 100 correcting lip-reading predictions, which may be used for implementations described herein. Environment 100 of FIG. 1 illustrates an overall pipeline for correcting lip-reading predictions. In some implementations, environment 100 includes a system 102 that receives video input, and outputs sentence predictions based on word predictions from the video input.

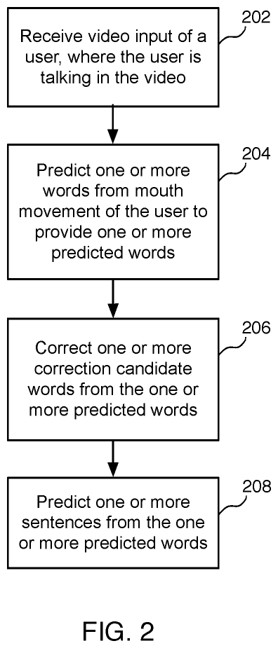

As described in more detail herein, in various implementations, deep learning lip-reading module 104 of system 102 performs the word predictions. NLP module 106 of system 102 performs the corrections of the correction candidate words and performs the sentence word predictions. Various implementations directed to word predictions and sentence predictions are described in more detail herein, in connection with FIG. 2, for example.

For ease of illustration, FIG. 1 shows one block for each of system 102, deep learning lip-reading module 104, and NLP module 106. Blocks 102, 104, and 106 may represent multiple systems, deep learning lip-reading modules, and NLP modules. In other implementations, environment 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein.

FIG. 2 is an example flow diagram for correcting lip-reading predictions, according to some implementations. Implementations described herein provide a pipeline using NLP to correct word predictions of deep learning models and to predict sentences predictions. Referring to both FIGS. 1 and 2, a method is initiated at block 202, where a system such as system 102 receives video input of a user, where the user is talking in the video input (e.g., video). In various implementations, the system extracts images from the video and identifies the mouth of the user. For example, the system may receive 90 frames of images for 3 seconds, and the lip-reading module may use a lip-reading model to identify the mouth of the user in different positions. In some implementations, the system crops the mouth of the user in the video for analysis, where mouth shapes and mouth movements are feature regions.

At block 204, the system predicts one or more words from the mouth movement of the user to provide one or more predicted words. In various implementations, the system predicts the one or more words based on deep learning. For example, in various implementations, deep learning lip-reading module 104 of system 102 applies a lip-reading model to determine or predict words from the mouth movements.

In various implementations, lip reading is the process of the system understanding what is being spoken based solely on the video (e.g., no voice but merely visual information). Because lip reading depends on visual clues (e.g., mouth movement), some mouth shapes look very similar. The may result in inaccuracies.

In the example above in connection with FIG. 1, deep learning lip-reading module 104 of system 102 predicts words using a lip-reading model for word prediction. For example, deep learning lip-reading may predict individual words, “AYL.,” “BIY.,” “BAEK.” These words would result in the sentence, “Ayl biy baek,” based on deep learning.

In another example, mouth movements for the sounds “th” and “f” may be difficult to decipher. As such, detecting subtle characters and/or words are important. In another example, mouth movements for the words “too” and “to” appear very close if not identical. In various implementations, deep learning lip-reading module 104 of system 102 applies a lip-reading model to determine ground truth word predictions using mere mouth movement with no sound.

Subsequently, as described below in connection with block 206, NLP module 106 of system 102 applies a lip-reading model to correct any inaccurately predicted words. As described in more detail herein, NLP module 106 utilizes NLP to determine or predict words accurately including correcting inaccurate word predictions, and to accurately predict expressions or sentences from a string of predicted words.

At block 206, the system corrects one or more correction candidate words from the one or more predicted words. While deep learning lip-reading module 104 functions to predict individual words, NLP module 106 functions to correct inaccurately predicted words from lip-reading module 104, as well as to predict expressions or sentences from the user.

In various implementations, the system utilizes NLP techniques to interpret natural language, including speech and text. NLP enables machines to understand and extract patterns from such text data by applying various techniques such as text similarity, information retrieval, document classification, entity extraction, clustering, etc. NLP is generally used for text classification, chatbots for virtual assistants, text extraction and machine translation.

In various implementations, NLP module 106 of system 102 corrects the one or more correction candidate words based on natural language processing. Correction candidate words may be words that do not appear to be correct. For example, the word predictions “AYL.,” “BIY.,” and “BAEK.” are not words found in the English dictionary, and are thus correction candidates. In various implementations, NLP module 106 of system 102 performs the corrections of these correction candidate words.

In various implementations, NLP module 106 converts or maps each predicted word received into a vector or number (e.g., a string of digits). For example, NLP module 106 may map “AYL.” to digits 1 0 0, map “BIY.” to digits 0 1 0, and map “BAEK.” to digits 0 0 1. In various implementations, NLP module 106 also converts or maps one or more other words to these vectors or digits. For example, NLP module 106 may map “I'll” to digits 1 0 0, map “be” to digits 0 1 0, and map “back” to digits 0 0 1. When NLP module 106 receives a word and maps the word to a vector or digits, NLP module 106 compares the vector to other stored vectors, and identifies the closest vector.

In this example implementation, NLP module 106 determines that “AYL.” and “I'll” both map to vector or digits 1 0 0, “BIY.” and “be” both map to vector or digits 0 1 0, and “BAEK.” and “back” both map to vector or digits 0 0 1. Accordingly, NLP module 106 corrects “AYL.” to “I'll,” corrects “BIY.” to “be,” and corrects “BAEK.” to “back.”

At block 208, the system predicts one or more sentences from the one or more predicted words. In various implementations, NLP module 106 of system 102 performs expression or sentence word predictions. As indicated above, NLP module 106 corrects “AYL.” to “I'll,” corrects “BIY.” to “be,” and corrects “BAEK.” to “back.” NLP module 106 of system 102 subsequently predicts the sentence, “I'll be back.” In other words, NLP module 106 corrects correction candidates “AYL. BIY. BAEK.” to “I'll be back,” which is the closest expression.

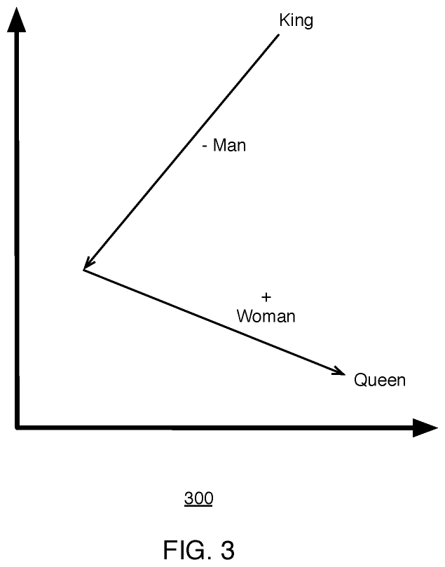

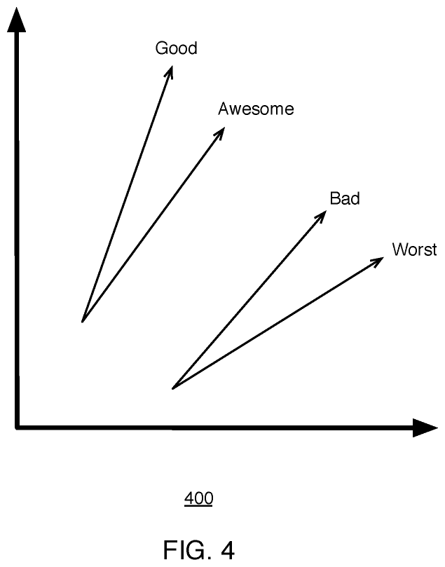

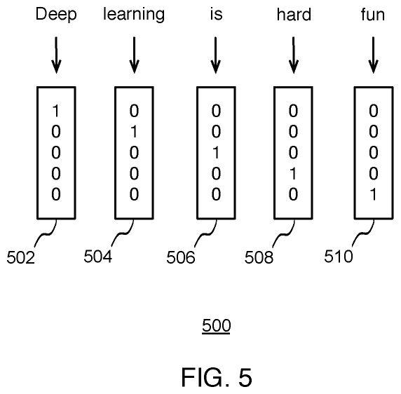

FIGS. 3 and 4 provide additional example implementations directed to word prediction. FIG. 5 provides additional example implementations directed to sentence prediction.

FIG. 3 is an example diagram showing word vectors used in word predictions based on analogy, according to some implementations. In various implementations, NLP module 106 of system 102 corrects the one or more correction candidate words based on analogy. For example, as indicated above, NLP module 106 find words that are most similar, in this case based on word analogy. The word “king” is to the word “queen” as the word “man” is to “woman.” Based on word analogy, “king” is close to “man,” and “queen” is close to “woman.”

FIG. 4 is an example diagram showing word vectors used in word predictions based on word similarity, according to some implementations. In various implementations, the system corrects the one or more correction candidate words based on word similarity. For example, as indicated above, NLP module 106 finds words that are most similar, in this case based on similarity of word meaning. The words “good” and “awesome” are relatively close to each other, and the words “bad” and “worst” are relatively close to each other. These pairings contain words that are similar in meaning.

As indicated herein, in various implementations, the system corrects the one or more correction candidate words based on vector similarity. In various implementations, vectors are numbers that the system can compare. The system performs corrections by finding similarity between word vectors in the vector space. Because computer programs process numbers, the system converts or encodes text data to a numeric format in the vector space, as described herein.

In some implementations, the system determines word similarity between two words and designates a number range. For example, a number range may be values between values 0 to 1. A number value in the number range indicates how close the two words are, semantically. For example, a value of 0 may mean that the words are not close, and instead are very different in meaning. A value of 0.5 may mean that the words are very close in meaning, or even synonyms. In various implementations, the system corrects the one or more correction candidate words based on cosine similarity. The cosine may be defined as a distance between two vectors, each vector representing a word. Referring to FIG. 4, the words “good” and “awesome” are close. Also, the words “bad” and “worst” are close. These pairings have cosine similarity.

In various implementations, during encoding, the system takes as its input a large corpus of text and produces a vector space. The size of the vector space may vary, depending on the particular implementation. For example, the vector space may be of several hundred dimensions. In various implementations, the system assigns each unique word in the corpus a corresponding vector in the space.

Once the system has vectors of the given chunk of text, the system computes the similarity between generated vectors. The system may utilize any suitable statistical techniques for determining the vector similarity. Such techniques are cosine similarity. In another example, the lip-reading module 104 may predict, “Im stop hot.” NLP module 106 may in turn take “Im stop hot” as the input, compare the input with the most similar sentences in the vector spaces. As a result, NLP module 106 finds and outputs “I'm too hot.”

FIG. 5 is an example diagram showing a mapping of predicted words to digits, according to some implementations. Shown are words “deep,” “learning,” “is,” “hard,” and “fun.” In various implementations, the NLP module of the system converts each predicted word into a series of digits readable by a machine or computer. For example, “deep” maps to digits 502 (e.g., 1 0 0 0 0), “learning” maps to digits 504 (e.g., 0 1 0 0 0), “is” maps to digits 506 (e.g., 0 0 1 0 0), “hard” maps to digits 508 (e.g., 0 0 0 1 0), and “fun” maps to digits 510 (e.g., 0 0 0 0 1). While the digits shown are in binary, other digit schemes may be used (e.g., hexadecimal, etc.)

In various implementations, the NLP module of the system assigns digits to words based on word similarity and/or based on grammar rules and word positioning. For example, the system may map the word “hard” and the word “difficult” to the digits 0 0 0 1 0. These words are similar in meaning. The system may map the word “fun” and the word “joyful” to digits 0 0 0 0 1. These words are similar in meaning. While the words “hard” and “fun” are different words, the system may assign digits that are closer together based grammar rules and word positioning. For example, “hard” and “fun” are adjectives that are positioned at the end of the word string “deep,” “learning,” “is,” “hard,” and “fun.”

In the example shown, the NLP module of the system may predict two different yet similar sentences. One sentence may be predicted to be “Deep learning is hard.” The other sentence may be predicted to be “Deep learning is fun.” The system may ultimately predict one sentence over the other based on the individual words predicted. For example, if the last word of the word string is “fun,” the system will ultimately predict the sentence “Deep learning is fun.” Even if the last word of the string is incorrectly predicted by the deep learning module as “funn,” or “fuun,” the system would assign the digits 0 0 0 0 1 to the predicted word. Because the system also assigns the digits 0 0 0 0 1 to the word “fun,” the system will use the word “fun,” because it is a real word. As such, the predicted sentence (“Deep learning is fun.”) makes sense and thus would be selected by the system.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, implementations combine lip-reading techniques using a deep learning model and word correction techniques using NLP techniques. Implementations utilize NLP to correct inaccurate word predictions that a lip-reading model infers. Implementations described herein also apply to noisy environments or when there is background noise (e.g., taking a customer's order at a drive-through, etc.).

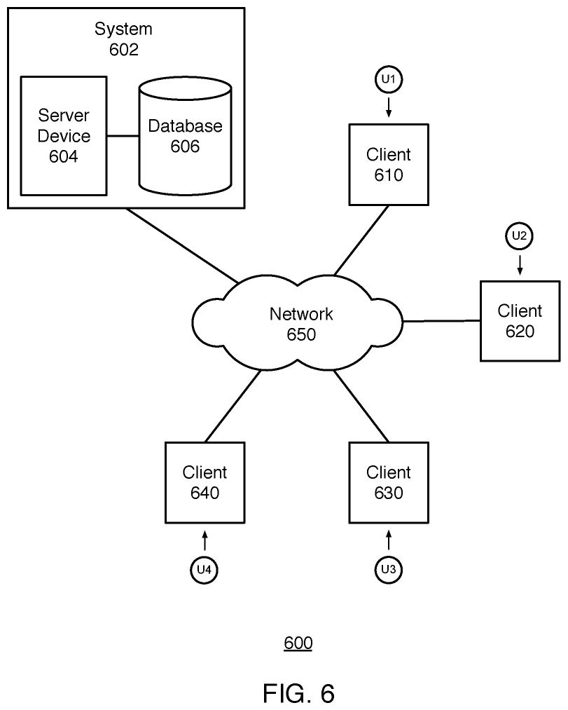

FIG. 6 is a block diagram of an example network environment 600, which may be used for some implementations described herein. In some implementations, network environment 600 includes a system 602, which includes a server device 604 and a database 606. For example, system 602 may be used to implement system 102 of FIG. 1, as well as to perform implementations described herein. Network environment 600 also includes client devices 610, 620, 630, and 640, which may communicate with system 602 and/or may communicate with each other directly or via system 602. Network environment 600 also includes a network 650 through which system 602 and client devices 610, 620, 630, and 640 communicate. Network 650 may be any suitable communication network such as a Wi-Fi network, Bluetooth network, the Internet, etc.

For ease of illustration, FIG. 6 shows one block for each of system 602, server device 604, and network database 606, and shows four blocks for client devices 610, 620, 630, and 640. Blocks 602, 604, and 606 may represent multiple systems, server devices, and network databases. Also, there may be any number of client devices. In other implementations, environment 600 may not have all of the components shown and/or may have other elements including other types of elements instead of, or in addition to, those shown herein.

While server device 604 of system 602 performs implementations described herein, in other implementations, any suitable component or combination of components associated with system 602 or any suitable processor or processors associated with system 602 may facilitate performing the implementations described herein.

In the various implementations described herein, a processor of system 602 and/or a processor of any client device 610, 620, 630, and 640 cause the elements described herein (e.g., information, etc.) to be displayed in a user interface on one or more display screens.

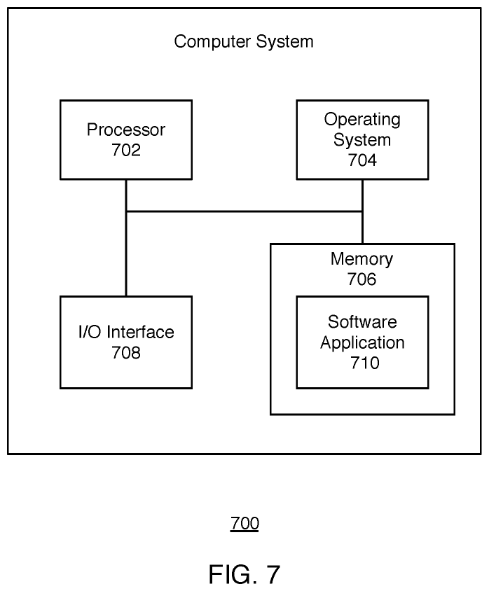

FIG. 7 is a block diagram of an example computer system 700, which may be used for some implementations described herein. For example, computer system 700 may be used to implement server device 604 of FIG. 6 and/or system 102 of FIG. 1, as well as to perform implementations described herein. In some implementations, computer system 700 may include a processor 702, an operating system 704, a memory 706, and an input/output (I/O) interface 708. In various implementations, processor 702 may be used to implement various functions and features described herein, as well as to perform the method implementations described herein. While processor 702 is described as performing implementations described herein, any suitable component or combination of components of computer system 700 or any suitable processor or processors associated with computer system 700 or any suitable system may perform the steps described. Implementations described herein may be carried out on a user device, on a server, or a combination of both.

Computer system 700 also includes a software application 710, which may be stored on memory 706 or on any other suitable storage location or computer-readable medium. Software application 710 provides instructions that enable processor 702 to perform the implementations described herein and other functions. Software application may also include an engine such as a network engine for performing various functions associated with one or more networks and network communications. The components of computer system 700 may be implemented by one or more processors or any combination of hardware devices, as well as any combination of hardware, software, firmware, etc.

For ease of illustration, FIG. 7 shows one block for each of processor 702, operating system 704, memory 706, I/O interface 708, and software application 710. These blocks 702, 704, 706, 708, and 710 may represent multiple processors, operating systems, memories, I/O interfaces, and software applications. In various implementations, computer system 700 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular implementations may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular implementations can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
receiving video input of a user, wherein the user is talking in the video input;
predicting one or more words from mouth movement of the user to provide one or more predicted words;
correcting one or more correction candidate words from the one or more predicted words; and
predicting one or more sentences from the one or more predicted words.

2. The system of claim 1, wherein the predicting of the one or more words is based on deep learning.

3. The system of claim 1, wherein the correcting of the one or more correction candidate words is based on natural language processing.

4. The system of claim 1, wherein the correcting of the one or more correction candidate words is based on analogy.

5. The system of claim 1, wherein the correcting of the one or more correction candidate words is based on word similarity.

6. The system of claim 1, wherein the correcting of the one or more correction candidate words is based on vector similarity.

7. The system of claim 1, wherein the correcting of the one or more correction candidate words is based on cosine similarity.

8. A non-transitory computer-readable storage medium with program instructions stored thereon, the program instructions when executed by one or more processors are operable to cause the one or more processors to perform operations comprising:
receiving video input of a user, wherein the user is talking in the video input;
predicting one or more words from mouth movement of the user to provide one or more predicted words;
correcting one or more correction candidate words from the one or more predicted words; and
predicting one or more sentences from the one or more predicted words.

9. The computer-readable storage medium of claim 8, wherein the predicting of the one or more words is based on deep learning.

10. The computer-readable storage medium of claim 8, wherein the correcting of the one or more correction candidate words is based on natural language processing.

11. The computer-readable storage medium of claim 8, wherein the correcting of the one or more correction candidate words is based on analogy.

12. The computer-readable storage medium of claim 8, wherein the correcting of the one or more correction candidate words is based on word similarity.

13. The computer-readable storage medium of claim 8, wherein the correcting of the one or more correction candidate words is based on vector similarity.

14. The computer-readable storage medium of claim 8, wherein the correcting of the one or more correction candidate words is based on cosine similarity.

15. A computer-implemented method comprising:
receiving video input of a user, wherein the user is talking in the video input;
predicting one or more words from mouth movement of the user to provide one or more predicted words;
correcting one or more correction candidate words from the one or more predicted words; and
predicting one or more sentences from the one or more predicted words.

16. The method of claim 15, wherein the predicting of the one or more words is based on deep learning.

17. The method of claim 15, wherein the correcting of the one or more correction candidate words is based on natural language processing.

18. The method of claim 15, wherein the correcting of the one or more correction candidate words is based on analogy.

19. The method of claim 15, wherein the correcting of the one or more correction candidate words is based on word similarity.

20. The method of claim 15, wherein the correcting of the one or more correction candidate words is based on vector similarity.
